(19) United States
(12) Patent Application Publication
(10) Pub. No.: US 2007/0296286 A1
(43) Pub. Date: Dec. 27, 2007

(54) Powered Hand Tool

(76) Inventor: Eric Gwyn Avenell, Auckland (NZ)

Correspondence Address: Blakely, Sokoloff, Taylor & Zafman, 12400 Wilshire Boulevard, 7th Floor, Los Angeles, CA, 90025, US

(21) Appl. No.: 10/577,690

(22) PCT Filed: Oct. 28, 2004
(86) PCT No.: PCT/NZ04/00269

§ 371 Date: Mar. 12, 2007

(30) Foreign Application Priority Data
Oct. 28, 2003 (NZ) 529179
May 13, 2004 (NZ) 532925

(51) Int. Cl. B25F 1/00

(52) U.S. Cl. 310/50; 173/217; 318/254

(57) ABSTRACT

The invention relates to a hand tool for use with attachments. The hand tools of the invention may be used with attachments with various speed and torque requirements. Preferred hand tools comprise a body with a brushless DC motor and means. which control the energisation of the motor. In use the brushless DC motor of the preferred hand tool is electrically supplied to drive a power output means connected to said motor. Another preferred hand tool comprises a body with a motor contained therein, a void space between an internal surface of the body and at least a part of the motor, a fluid inlet port provided and a fluid outlet port provided in or on the body, and ducting means which provides a channel for fluid supplied via the fluid inlet port to and from the void space and then on to the fluid outlet port.

### TECHNICAL FIELD

This invention relates to a hand tool and in particular, though not solely, this invention relates to a powered hand tool for use with a variety of working end attachments with varied speed and/or torque requirements.

### BACKGROUND ART

Powered hand tools may have a number of size, weight and motor output considerations depending upon their use. For example, a power tool which is likely to be held and operated for extended periods of time is desirably of a weight and size which does not produce or minimises stress and muscle fatigue to an operator.

Operator fatigue while using power tools can lead to unnecessary accidents which are to be especially avoided in a workplace where individual and group safety is of prime importance. In the food industry, particularly the meat works industry, the trimming of meat from carcasses is performed by a variety of fixed cutting tools such as knives as well as smaller more maneuverable power hand tools.

There is a requirement of powered hand tools to provide variable output speeds and/or torque applied to implements that may be connected to the output shaft. It is also desirable that a powered hand tool provide a power output means, such as a rotating shaft, cog or gear-head which Is capable of connecting with a number of tooling attachment pieces.

Meat from a carcass which remains close to joints and/or bones is useful, and can be obtained by the skillful operation of suitable cutting tools. In the past, hand knives have been used for this purpose, but more often the mechanisation of cutting implements is being employed such that in recent times a number of hand tools with cutting implements attached have been developed. Such hand tools have been powered pneumatically from an external pneumatic compressor system, or by an electrical power system which drives a remote motor to generate rotation in a flexible shaft which extends to the cutting implement end of the hand tool. Such systems however tend not to provide efficient or effective power outputs to the hand tools, with pneumatic systems requiring suitable compressors and air filtration units to enable the necessary hygiene for a pressurised air supply; with the maneuverability and location of the hand tool being determined by the length of the air supply hose. Electrically driven flexible shaft systems may tend to cause excessive vibration, and are also strictly limited to the length of flexible shaft.

U.S. Pat. No. 5,522,142A discloses a powered hand tool in the form of a rotary knife incorporating a brushed DC motor. However, the incorporation of a brushed DC motor introduces a number of drawbacks into the flexibility of the tool and places restrictions on the operation of the tool. For example, brushed motors tend to have a reduced operational lifetime as the brushes wear out, dust can be generated from the degradation of the brushes over time (which can have detrimental affects on hygienic operations) generally are unable to run at the higher speeds (revolutions per minute, r.p.m.) compared to brushless motors, and are also generally unable to supply the constant torque and speed of a brushless motor configuration.

A hand tool with particular utility in the food/meat works industry is desirable, especially one which has advantages over the existing hand tools employed.

It is therefore an object of the present invention to provide a powered hand tool which will go at least some way towards addressing the foregoing problems or which will at least provide the industry with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

Accordingly, in a first aspect, the invention may broadly be said to consist in a hand tool comprising:
a body, the body containing a brushless DC motor, and
motor control means which controls energisation of the motor,
   wherein said brushless DC motor is electrically supplied to drive a power output means connected to said motor.

Preferably, the hand tool includes a rotor position sensing means which outputs a signal which enables the position of the motor's rotor to be determined.

Preferably, the energisation of the motor is determined at least in part on the basis of the rotor position signal.

Preferably, the power output means is a shaft capable of providing a driving force to a connected implement.

Preferably, the power output means comprises a rotating shaft, a toothed wheel or cog, disc or other suitable gear head.

Preferably, the power output means includes a gearing system able to translate the power output by the shaft to a pre-determined speed or torque.

Preferably, the rotor position sensing means comprises a Hall effect sensor.

Preferably, the motor control means receives manual speed demand input and varies the output speed and/or torque of said brushless DC motor accordingly.

Preferably, a switch is provided for switching electrical supply to said brushless DC motor on and/or off.

Preferably, said switch is a non-contact magnetic reed switch located within the body which Is sealed.

Preferably, the hand tool includes power input means adapted to be supplied with an input DC voltage via a connectable power cable.

Preferably, the power input means comprises a quick-release plug or socket type arrangement.

Preferably, a control system is utilised which monitors the level of power supply to the hand tool.

Preferably, the control system includes a power disabling switch.

Preferably, the implement may be an implement selected from one of the following types: a rotatable circular blade, a reciprocating blade, a pair of connected reciprocating blades, a rotating drum past a blade, a universal connection means able to attach or fit or house a tool.

Preferably, the hand tool includes heat dissipation and/or insulation means.

Preferably, the heat dissipation means are cooling fins.

Preferably, the insulation means substantially surrounds heat generating hand tool components and substantially reduces heat transfer from said hand tool body from transferring heat to an operator.

Preferably, the hand tool is constructed of metallic, plastics or composite materials.

Preferably, the body is sealed.

Preferably, the body is substantially cylindrical in shape and sized to fit into a user's hand.

In a second aspect, the present invention may broadly be said to consist in a hand tool comprising:
a body,
a motor contained within the body,
a void space between an internal surface of the body and at least a part of the motor,
a fluid inlet port provided in or on the body,
a fluid outlet port provided in or on the body, and
ducting means which provides a channel for fluid supplied via the fluid inlet port to and from the void space and then on to the fluid outlet port.

Preferably, the motor is a brushless DC motor which is sealed within a motor housing, the void space existing between the internal surface of the body and at least a part of the motor housing.

Preferably, the motor housing and body are both substantially cylindrical in shape and are aligned coaxially with the void space existing over substantially all of the radially extending region between the motor housing and body.

Preferably, the ducting means causes the fluid supplied to the fluid inlet port to, within the void space, first travelling in a direction parallel to the axis of the body and motor housing and then to travel about the axis before again travelling along the axis to the fluid outlet port.

Preferably, the fluid supplied to the void space provides cooling to the motor.

Preferably, the fluid supplied to the void space is a compressed pneumatic fluid.

Preferably, the fluid supplied to the void space is at a pressure greater than the external environment pressure.

Preferably, the fluid supplied to the void space maintains the motor temperature between about 35° C. to about 50°0 C., and/or maintains the external temperature of the body between about 25° C. to about 40° C.

Preferably, the fluid supplied to the void space is provided at between about 15 L/min to about 35 L/min, at between about 1.5 Bar to about 3.0 Bar, and at between about 80° C. to about 22° C.

Preferably, the body is adapted to connect to a supply conduit via a quick-release fitting.

Preferably, the supply conduit provides electrical power to the motor as well as said fluid supply to said fluid inlet port and a path to allow fluid to flow from said fluid outlet port.

Preferably, fluid is supplied to the void space when the supply conduit is connected to the body.

Alternatively, fluid is supplied to the void space only when the motor is operational.

Preferably, a power switch handle is used to activate the hand tool.

Preferably, activation is achieved by pushing a base of a plunger on the handle forward against a biasing force and enabling activation of a sensing switch.

Preferably, activation of the switch may be via movement of a bevelled surface of the plunger against the switch and then by holding the handle down flush with the hand tool body.

Preferably, a control system is utilised which monitors the level of power supply and/or motor cooling fluid supply to the hand tool.

Preferably, the control system includes a power disabling switch.

### BRIEF DESCRIPTION OF DRAWINGS

Further aspects of the present invention will become apparent from the following description which is given by way of example only and with reference to the accompanying drawings in which:

FIG. 1 is a partial cutaway side elevation of one embodiment of a hand tool according to the present invention;

FIG. 2 is a partial cutaway perspective view of the power output means of FIG. 1 showing the implement connection end of the hand tool;

FIG. 3 is a perspective view of the hand tool of FIG. 1 with an implement attached at its implement connection end;

FIG. 4 is a perspective view of a second embodiment of the present invention illustrating a void space between the body and motor, in a partially disassembled state;

FIG. 5A is a partial cutaway side elevation of an embodiment of the hand tool according to the second embodiment of the present invention;

FIG. 5B is a cutaway side elevation of the embodiment of the hand tool as illustrated in FIG. 5A;

FIG. 6 is a side elevation view of an embodiment of the hand tool of FIG. 4 in an assembled state;

FIG. 7 is a partial cutaway perspective view of the power output means of the hand tool of FIG. 4,

FIG. 8 is a top perspective view of the hand tool of FIG. 7 with an implement connected to the power output means, and

FIG. 9 is a side perspective view of a hand tool of FIG. 8 in a disassembled state without the implement.

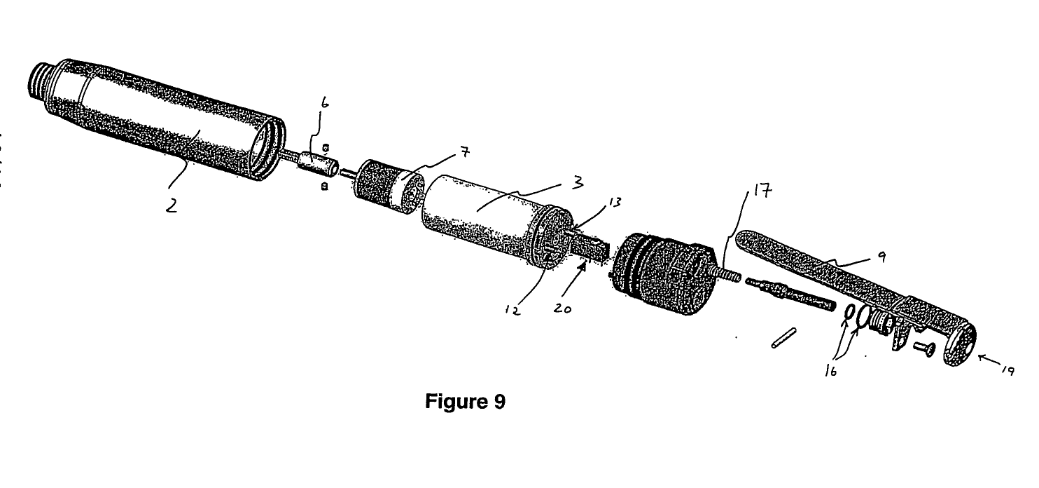

### BEST MODES FOR CARRYING OUT THE INVENTION

A hand tool generally in accordance with a preferred embodiment of the present invention will now be described with reference to the above Figures.

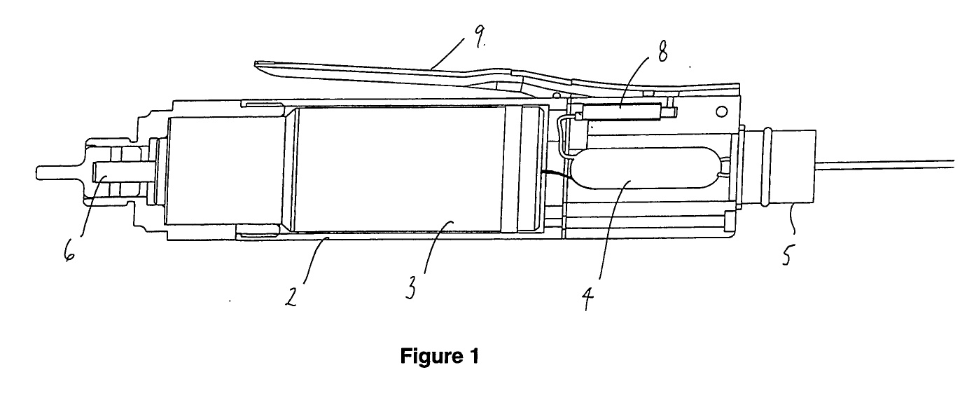

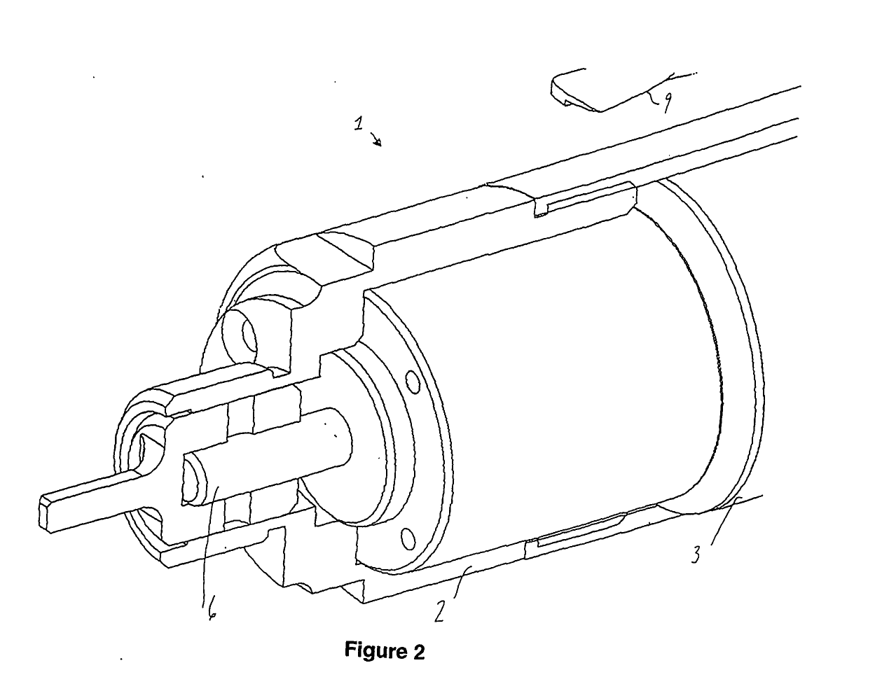

In a preferred embodiment of the present invention, and with references to FIGS. 1, 2 and 3 there is provided a hand tool 1, with a body or housing 2 which contains a brushless DC motor 3. A motor control means, such as a controller 4 Is provided to control the level of energisation level and timing to the various motor windings. An electrical power supply (not shown) is provided remotely to provide power to energise the motor. The power supply preferably outputs a DC supply voltage so that the hand tool need not include the bulk or weight of a transformer. Power is provided to the hand tool via power input means such as connector 5 and the mechanical rotary output of the motor 3 is provided via power output means or shaft 6.

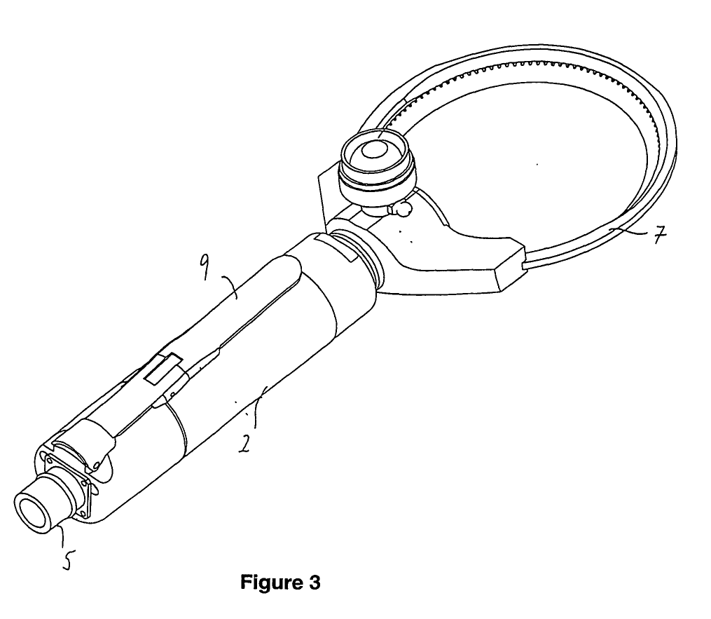

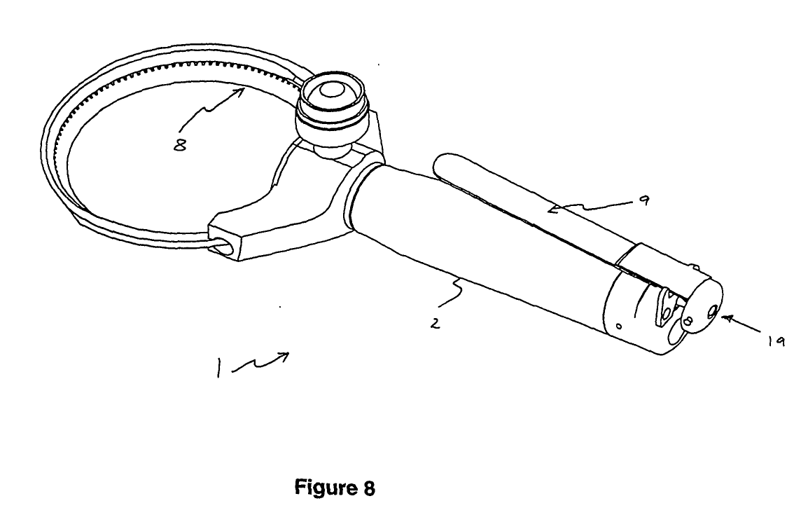

The power output means or shaft 6 provides a driving force to a connected implement 7 (such as the rotary blade shown in FIG. 3 or 8), although it should be appreciated that any driveable implement may be connected to the hand tool power output means or shaft 6, for example a Phillips or flat-head style screwdriver bit, a drill bit or a rotating disc capable of having sandpaper or an abrasive or polishing medium attached thereto.

Power output means or shaft 6 may be configured for connection to a rotating output shaft, a toothed wheel or cog, a disc or other suitable gear head to transfer power from the motor to a connected implement requiring a power drive. Such a power drive requirement may be a rotational movement although this may be translated to drive a reciprocating blade or hammer type drive. Implements that may be connected to the power output means may for example be a rotatable circular blade, a reciprocating blade, a pair of connected reciprocating blades or a universal connection means able to clamp, fit or house a tool.

A gearing system 7 may also be included which is able to translate the power output by shaft 6 up or down to a required speed or torque.

Electrical supply to connector 5 is via a connectable power cable or similar low voltage switching device. A quick release plug or socket type arrangement may be provided and power supplied to the motor controller or motor may be controlled manually by a user operating a switch in response to movement of handle 9 such as a non-contact magnetic reed switch 8 which may be sealed within the body 2.

The hand tool 1 may also include heat dissipation such as cooling fins and/or insulation means (neither shown) to help prevent the hand tool or body 2 from overheating and transferring excessive heat to a user. In one embodiment of the present invention the brushless DC motor has thicker than usual external walls which have greater capacity to absorb heat generated from the motor. The insulation means may substantially or wholly line the interior of the hand tool body 2, although if such a system is used, it is appreciated that heat dissipation such as venting is required to help remove heat from motor operation, especially if the hand tool is a sealed unit.

A sealed body unit may provide a number of advantages, such as its ability to prevent dust and moisture entering the body and interfering with the motor, power control system or electrics which may render the hand tool unsafe for operation by a user in a wet environment. For example, a hand tool used within the meat works industry; where blood and other meat juices are prevalent, or in an industrial environment where use of power tools exposed to rain and/or humidity is likely to occur (for example on a construction site); it is desirable to provide a waterproofed system less likely to provide electrically unsafe operating conditions. This safety may be further enhanced by the inclusion to the hand tool system of an isolated power transformer, such as a 24 to 36 volt DC supply with overload protection. Such a transformer can be remotely mounted away from the operator, hand tool and wet conditions.

Further, as the switch can be of the non-contact variety, the body 2 may be better sealed off from the external environment as no special seal is required around the switching apparatus. Although any suitable switching mechanism can be employed.

A number of advantages exist due to the incorporation of a brushless DC motor within a hand tool body. For example, brushless DC motors in general tend to provide longer tool life durability, do not generate dust (which would otherwise be generated by the brushes of a brushed DC motor), are able to run at higher speeds more efficiently whilst also providing more constant torque and speed compared to brushed DC motors.

The brushless DC motor can also be designed with customised windings to achieve desired torque output, and include modified power output means able to accept and be coupled with a planetary gear head. The planetary gear head may be used to gear down the output speed of the motor in order to achieve required torque and to maintain a more constant speed for user comfort.

A brushless DC motor can overcome disadvantages with a number of pneumatic and electrically powered flexible drive shafts. For example, pneumatic units require a supply of high quality compressed air (which can be costly to provide and the hand tool power output can fluctuate with variations in air supply and motor wear. Existing hand tool units, such as electrically powered ones can often be subject to high levels of vibration, which when transmitted to a user creates an undesirable level of discomfort, and may also generate noise if not muffled effectively.

Electrically powered flexible drive shaft units generally require 240 or 110 volt AC supply which may unnecessarily increase the risk of electric shock injury. Also, users tend to be restricted in their reach with the tool which is governed by the length of the flexible shaft, and may not have a hand tool on/off control system which can make them inherently more dangerous, especially if dropped when in use. The flexible shafts are also a maintenance concern. These types of hand tools also tend to have restricted movement due to the limited range of bending radii of the flexible shaft, and may also be subject to excess vibration. Due to the nature of the electrical power supply generally required there are strict earthing requirements for the hand tools, and different standards of electrical configuration due to different supply voltages can also be overcome by a motor able to be varied by the voltage input.

Previously, brushless DC motors have not been considered for incorporation in fluid-tight sealed or encapsulated hand tools, especially on the meat works industry. The applicant has however determined that there are a number of benefits to be obtained by incorporating a brushless DC motor in a powered hand tool and has managed to overcome various difficulties (both assumed and actual) in incorporating a brushless DC motor within a powered hand tool having dimensions suitable to allow the tool to be hand held. For example, miniaturisation of the motor has been necessary but it is expected that it will be possible to produce a hand tool which is substantially cylindrical in shape having an outer diameter of between 40 to 45 mm, preferably 42 mm and a length of 15 to 20 cm.

The present invention also provides for a hand tool with a power output means which is adapted to drive multiple different connectable implements such that the hand tool becomes the centre of a modular hand held power tool system. The brushless DC motor and gear head (having a ratio of about 4.4 to 5.4:1) may provide an output shaft rotational speed of about 3000-5000 r.p.m. with torque of about 880 gf·cm, dependent upon the desired application. The actual motor r.p.m. could vary between 20,000-30,000 r.p.m., with the motor speed being controlled via the input voltage to the controller, the controller itself, or alternatively via the use of a different geared system. Similarly, torque can be varied depending on the gearing system used.

One particular example of a suitable brushless DC motor, especially suitable for the second embodiment described below would be a motor unit having dimensions 27 mm diameter, 65 mm in length; and having 4 turns of coil. It has approximately 800 r.p.m. per volt applied, and has an operating voltage of approximately 24 volts.

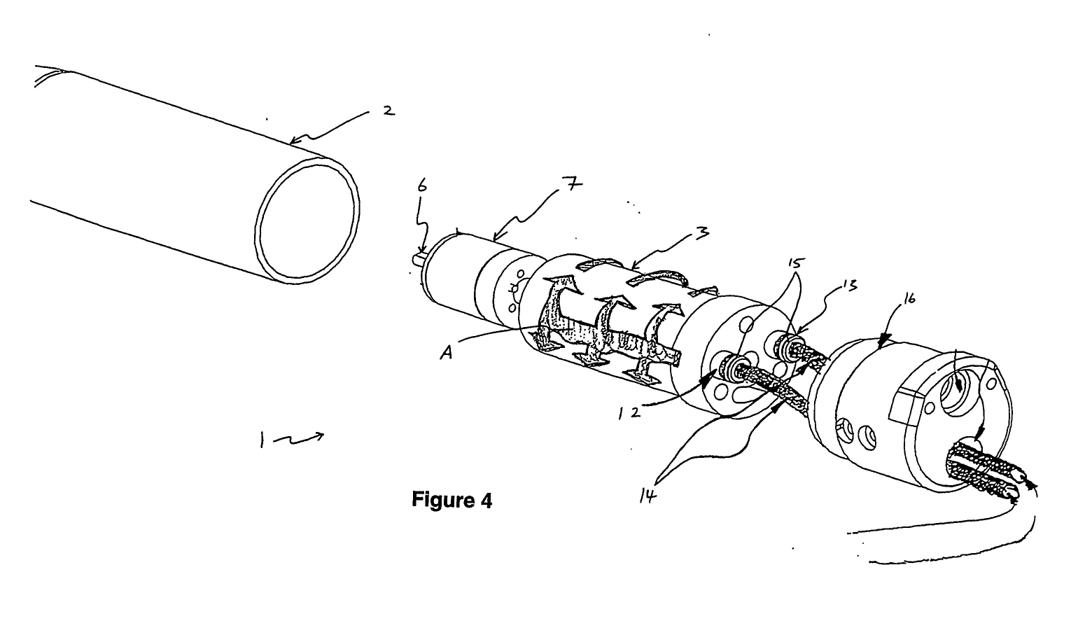

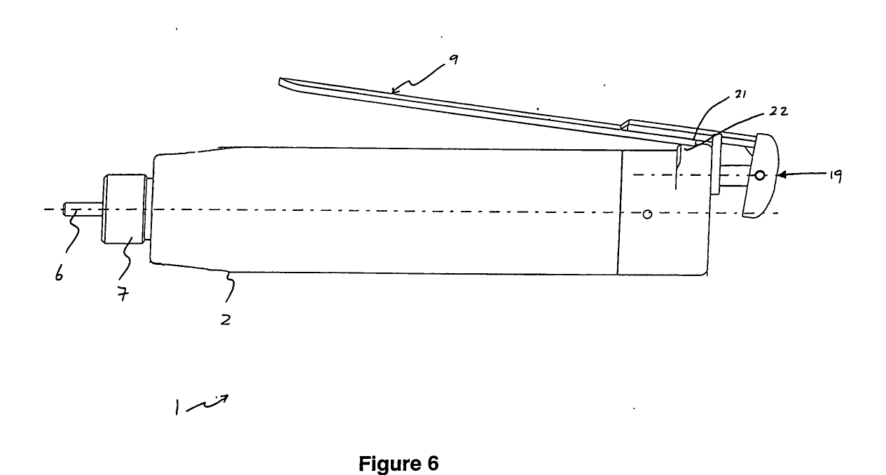

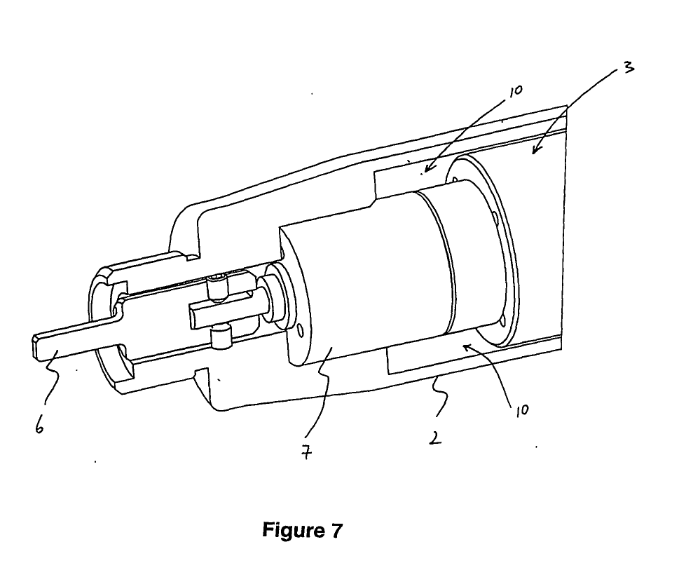

In a second embodiment of the present invention, and with reference to FIGS. 4 to 8, a hand tool 1 has a body (or housing) 2 containing a motor 3 the motor may be a brushless DC motor in which case it is able to be sealed within a motor housing. The body is configured to provide an air gap 10 about the motor 3 and between the internal surface 11 of the body 2 to thereby provide a void space about the motor. A pressurised fluid supply may be supplied to the void space via a fluid inlet port 12, ducted through the void space 10 (for example, following the flow path indicated by arrows A) by ducting means, and removed via a fluid outlet port 13. The brushless DC motor is electrically supplied to drive a power output means (or shaft) 6 connected to the motor 3.

The fluid used for cooling purposes may be air, water or any other fluid capable of controlling the hand tool's temperature to within desired operational conditions.

Although the introduction of a brushless DC motor 3 into such a hand tool 2 has significant advantages in itself, a problem with the heat dissipation from sealed units which contain operational heat generating devices, such as brushless DC motors, can lead to problems of its own. In particular, the accumulation of heat from the motor in the hand tool of the present invention may lead to excessive overheating of the motor device itself and/or the body or housing (which a user of the hand tool is required to grip) which may lead to user discomfort.

Therefore, in order to ensure the advantages of the brushless DC motor can be utilised, and to help reduce potential motor overheating (and also allow the motor to operate at an efficient temperature), and minimise user discomfort, a more advanced cooling system is provided by the introduction of the air gap 10 about the motor and between the body itself, through which a cooling fluid (for example, air) may be ducted. In the embodiment shown, the radial extent of the air gap is about 1 mm; however it should be appreciated that different gap sizings are suitable, and may simply require varied fluid supply conditions (pressure, flow rate and temperature). The ducting means preferably helps direct the fluid supply around the motor and through the void space (or air gap) around the motor in a direction which best promotes heat transfer and therefore motor heat removal, before then being removed via the fluid outlet port.

The fluid supplied may be compressed in any compressor of suitable ability in order to achieve the desired supply pressures, and may be coupled with any suitable pump or blower which facilitates a desired flow rate. For example, advantageously the fluid supply maintains the motor temperature at between about 35° C. to about 50° C., and/or the external temperature of the body is maintained to between about 25° C. to about 40° C. Although more preferably, the motor does not exceed about 45° C., and the exterior of the hand tool body does not exceed about 35° C. Advantageously, cooling of the motor (and hand tool body consequently) provides a more comfortable temperature for a user to hold the body (high temperatures can be uncomfortable for a user).

The fluid is supplied at a sufficient flow-rate and/or temperature to achieve maintenance of the desired motor and body temperatures. The applicants have experimented and believe that one such range of conditions of an air supply may fall within a flow rate of between about 15 L/min to about 35 L/min, at between about 1.5 Bar to about 3.0 Bar, and at between about 8° C. to about 22° C. The applicants also appreciate that some level of filtering of the fluid may be required, in order to remove any particulate matter, which may clog or constrict the air gap and therefore the flow path, A, of the temperature controlling fluid. The air may be passed through a solenoid on/off valve that allows air to be switched on when the tool is connected with the power and/or fluid supply conduit (that is, the power supply cabling and fluid supply conduit may be contained within the same conduit sheath). Alternatively, the fluid is supplied only when the tool is running (the motor is energised) and remains off when the tool is disconnected from any remote controlling devices.

In both the first and second aspects of the present invention a controller can be employed to monitor the levels or power supply and/or motor cooling fluid supply to the hand tool. The controller, or control box may be a housing which includes hand tool and motor diagnostic equipment, and provides an indicator (both to a computer monitoring and/or visible indicators) system as to the power supply and cooling fluid supply. The control box can house equipment which ensures that a minimum of cooling fluid (or pneumatic cooling fluid) supply continually reaches the motor when it is in operation, or if this minimum requirement is not met (that is, the pressure and/or flowrate of the cooling fluid through the hand tool is not sufficiently high), the power supply to the hand tool may be suspended (disabled) until the supply is corrected.

Further, the control box should be mounted remotely to the hand tool, and can include an emergency power “off” of power disabling switch to stop the hand tool from operating. Such an emergency switch could be in the form of a high visibility (for example, red) push-type button switch located on the exterior of the control box housing.

The hand tool may also include suitable fluid inlet 12 and fluid outlet ports 13 adapted to connect to conduit 14 (through which the fluid is supplied and extracted from the hand tool as well as electrical power to drive the motor) via quick-release fittings 15. The use of quick release fittings allows a greater degree of flexibility for a hand tool user, for disconnection from the power system for hand tool maintenance, or simply if a hand tool needs to be changed.

The fluid supply is preferably supplied when the fluid/power conduit is connected to the hand tool, although in an alternative option the fluid supply may only be supplied when the hand tool is in operation. The hand tool may also include one or more sealing means, such as O-rings 16 or silicon based products, which may be utilised in order to help maintain a fluid-fight seal between the external environment and the inside of the hand tool body. Of course, any other suitable fluid sealing device or mechanism may be employed in order to achieve a fluid-tight seal. However, in the advent that the fluid-tight seal is broken, when the fluid is a gas, for example air, the pressurised air supply within said body is preferably supplied at a pressure greater than the external environment pressure and therefore any liquid ingress to the hand tool body 2 is prevented.

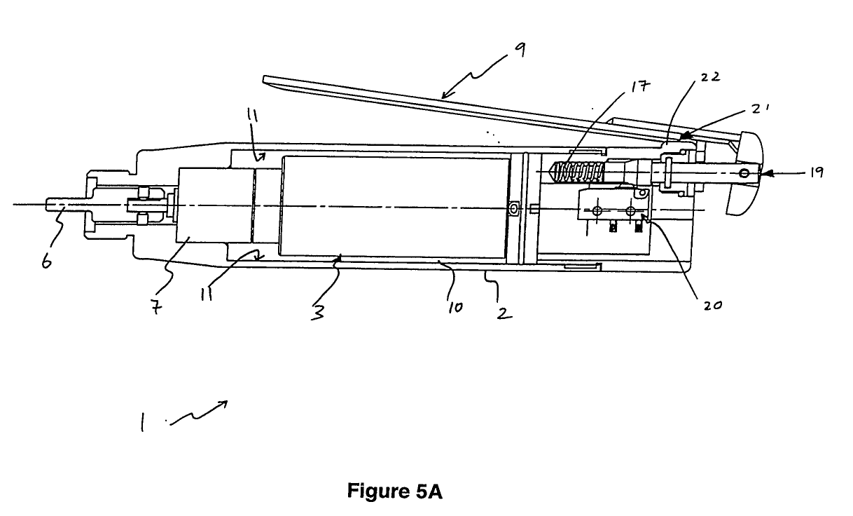

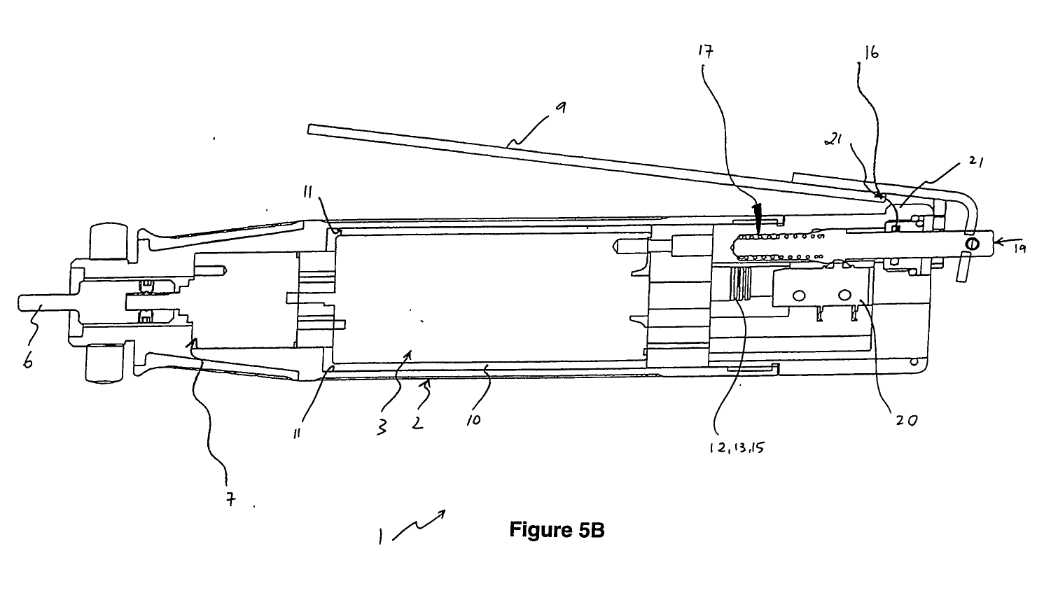

Given safety considerations for the operation of powered hand tools, an integral power switch 9 shown in FIG. 5A may be provided in order to activate the hand tool. A spring-loaded safety mechanism requires engagement prior to enabling activation of a second power activating switch to thereby operate the motor.

The activation/operation sequence can be achieved by pushing the base 19 of a plunger on the handle 9 forward against the biasing force of a spring 17 (thus enabling a micro-switch 20 via movement of a bevelled surface of the plunger against the switch) and then by holding the handle down flush with the hand tool body. By requiring a user to push the base 19 of the plunger forward against the biasing force, a user should be required to use one hand to hold the hand tool, and the other to push the base 19. Thereby providing an increased level of safety as a user should use two hands to hold and activate the tool which desirably eliminates the potential for a users free hand to become ensnared in an operating cutting blade implement attached to the hand tool.

The power activating switch may for example be similar to the magnetic reed switch 8 shown in the first embodiment. The switch design includes a ledge (or tapered step) 21 which fits over and latches to a lug 22 when the base 19 has been pushed in and then the handle 9 held flush with the body. Once in this position the biasing force of the spring 17 is transferred to the ledge (or tapered step) 21/lug 22 interface so that the user is simply required to maintain depression of the handle 9 in order to utilise the hand tool. Desirably, once the handle has been depressed toward the body of the tool, the ledge and lug design enable minimal force by a user to hold the handle in the depressed position (and thereby in an operating mode).

Given the spring-loaded plunger mechanism, if the switch handle is released at any time, the spring will promote the plunger outwards thereby deactivating the first mechanism switch 20, cutting power to the motor and therefore stopping hand tool operation. In addition, if this switch is not activated, and the switch handle is depressed towards the hand tool body, the tool will not start as the switch has not been activated (that is, micro-switch 20 has not been activated).

This invention is designed to overcome a number of disadvantages of existing hand tools, especially in regard to brushed DC motor or pneumatically driven power configurations. The invention also provides for a fluid-tight sealed power tool able to operate, whilst at the same time providing means for heat dissipation from the primary heat generating device, the brushless DC motor.

A hand tool which also provides a number of safety features which reduces the likelihood of injury in the work place is also desirable.

Aspects of the present invention have been described by way of example only and it should be appreciated that modifications and additions may be made thereto without departing from the scope thereof as defined in the appended claims.

1. A hand tool comprising:
a body,
a motor contained within the body,
a void space between an internal surface of the body and at least a part of the motor,
a fluid inlet port provided in or on the body,
a fluid outlet port provided in or on the body, and
ducting means which provides a channel for fluid supplied via the fluid inlet port through the void space and then on to the fluid outlet port,
said fluid outlet and inlet ports are connectable to fluid supply and fluid extraction conduits respectively,
characterised in that a fluid is supplied to said fluid inlet from an external fluid source.

2. A hand tool as claimed in claim 1 wherein said supply conduit and/or extraction conduit are releasably attachable to said fluid inlet and said fluid outlet respectively.

3. A hand tool as claimed in claim 1 including a fluid transport means capable of providing fluid flow from said external fluid source through said void space via the supply conduit and egressing via the extraction conduit.

4. A hand tool as claimed in claim 1 wherein said motor is a brushless DC motor.

5. A hand tool as claimed in claim 1 including a controller employed to monitor the temperature of the hand tool or at least one component therein and/or the level of power supply and/or the level of fluid supply to the hand tool.

6. A hand tool as claimed in claim 5 wherein the controller includes motor diagnostic equipment.

7. A hand tool as claimed in claim 5 wherein said controller is capable of providing a signal to a computer monitoring system to indicate said temperature, level of power supply and/or level of fluid supply.

8. A hand tool as claimed in claim 7 wherein the computer monitoring system regulates the power supply and/or fluid supply if said controller indicates that the temperature, level of power supply and/or level of fluid supply is outside of predetermined limits.

9. A hand tool as claimed in claim 5 wherein said controller is capable of providing a signal to a visible indicator system to indicate the level of power supply and/or level of fluid supply.

10. A hand tool as claimed in claim 9 wherein the visible indicator system is capable of indicating if the temperature, level of power supply and/or level of fluid supply is outside of predetermined limits.

11. A hand tool as claimed in claim 5 wherein the controller is mounted remotely to the hand tool.

12. A hand tool as claimed in claim 5, wherein the controller includes an emergency power “off” or power disabling switch.

13. A hand tool as claimed in any of claim 5, wherein said controller controls energisation of the motor.

14. A hand tool as claimed in claim 1, wherein the motor is sealed within a motor housing, the void space existing between the internal surface of the body and at least a part of the motor housing.

15. A hand tool as claimed in claim 1, wherein the fluid supplied to the void space provides cooling to the motor.

16. A hand tool as claimed in claim 1, wherein the fluid supplied to the void space is a compressed pneumatic fluid.

17. A hand tool as claimed in claim 1, wherein the fluid supplied to the void space is at a pressure greater than the external environment pressure.

18. A hand tool as claimed in claim 1, wherein the ducting means causes the fluid supplied to the fluid inlet port to, within the void space, first travel in a direction parallel to the axis of the body and motor housing and then to travel about the axis before again travelling along the axis to the fluid outlet port.

19. A hand tool as claimed in claim 1, wherein the fluid supplied to the void space maintains the motor temperature between about 35° C. to about 50° C., and/or maintains the external temperature of the body between about 25° C. to about 40° C.

20. A hand tool as claimed in claim 1, wherein the fluid supplied to the void space is provided at between about 15 L/min to about 35 L/min, at between about 1.5 Bar to about 3.0 Bar, and at between about 8° C. to about 22° C.

21. A hand tool as claimed in claim 1, wherein fluid is supplied to the void space only when the motor is operational.

22. A hand tool as claimed in claim 1, wherein the supply conduit also provides electrical power to the motor.

23. A hand tool as claimed in claim 1, wherein fluid is supplied to the void space only when the supply conduit is connected to the body.

24. A hand tool as claimed in claim 1, wherein said hand tool includes a power output means connected to the motor.

25. A hand tool as claimed in claim 24, wherein the power output means is a shaft capable of providing a driving force to a connected implement.

26. A hand tool as claimed in claim 25, wherein the implement may be an implement selected from one of the following types: a rotateable circular blade, a reciprocating blade, a pair of connected reciprocating blades, a rotating drum past a blade, a universal connection means able to attach or fit or house a tool.

27. A hand tool as claimed in claim 24, wherein the power output means comprises a rotating shaft, a toothed wheel or cog, disc or other suitable gear head.

28. A hand tool as claimed in claim 24, wherein the power output means includes a gearing system able to translate the power output by the shaft to a pre-determined speed or torque.

29. A hand tool as claimed in claim 1, wherein said hand tool includes a rotor position sensing means which outputs a signal which enables the position of the motor's rotor to be determined.

30. A hand tool as claimed in claim 29, wherein the rotor position sensing means comprises a Hall effect sensor.

31. A hand tool as claimed in claim 29, wherein energisation of the motor is determined at least in part on the basis of the rotor position signal.

32. A hand tool as claimed in claim 5, wherein the controller receives manual speed demand input and varies the output speed and/or torque of the motor accordingly.

33. A hand tool as claimed in claim 1, wherein a power switch handle is used to activate the hand tool.

34. A hand tool as claimed in claim 33, wherein activation is achieved by pushing a base of a plunger on the handle forward against a biasing force and enabling activation of a sensing switch.

35. A hand tool as claimed in claim 34, wherein activation of the switch may be via movement of a bevelled surface of the plunger against the switch and then by holding the handle down flush with the hand tool body.

36. A hand tool as claimed in claim 1, wherein a switch is provided for switching electrical supply to the motor on and/or off.

37. A hand tool as claimed in claim 36, wherein said switch is a non-contact magnetic reed switch located within the body which is sealed.

38. A hand tool as claimed in claim 1, wherein the hand tool includes a power input means adapted to be supplied with an input DC voltage via a connectable power cable.

39. A hand tool as claimed in claim 38, wherein the power input means comprises a quick-release plug or socket type arrangement.

40. A hand tool as claimed in claim 1, wherein the hand tool includes heat dissipation and/or insulation means.

41. A hand tool as claimed in claim 40, wherein the heat dissipation means are cooling fins.

42. A hand tool as claimed in claim 40, wherein the heat dissipation and/or insulation means substantially surrounds heat generating hand tool components and substantially reduces heat transfer from said hand tool body from transferring heat to an operator.

43. A hand tool as claimed in claim 1, wherein the hand tool is constructed of metal, plastics or composite materials.

44. A hand tool as claimed in claim 1, wherein the body is sealed.

45. A hand tool as claimed in claim 1, wherein the body is substantially cylindrical in shape and sized to fit into a user's hand.

46. A hand tool as claimed in claim 1, wherein the motor housing and body are both substantially cylindrical in shape and are aligned coaxially with the void space existing over substantially all of the radially extending region between the motor housing and body.
